(19) United States
(12) Patent Application Publication
(10) Pub. No.: US 2008/0273162 A1
(43) Pub. Date: Nov. 6, 2008

(54) Eyeglass hanging charm holder

(76) Inventor: Barbara Jean Porter, Husdon, FL (US)

Correspondence Address: Barbara Jean Porter, 11760 Lakewood Drive, Hudson, FL, 34669, US

(21) Appl. No.: 11/799,596

(22) Filed: May 3, 2007

(51) Int. Cl. G02C 11/02

(52) U.S. Cl. 351/52; 351/51

(57) ABSTRACT

A method of attachment for jewelry onto the temple arm or arms of a pair of eyeglasses is provided so that the wearer may adorn the eyeglasses in a purely esthetic manner. The eyeglass hanging charm holder may hold one jewelry article that is easily releasable or several at one time. The eyeglass hanging charm holder may be easily removed as it has an adjustable sliding loop that is adaptable to most conventional eyeglass temple stems. Furthermore the eyeglass hanging charm holder may be placed along any length of the temple arms and in any number desired. Once the user identifies the desired location for the eyeglass hanging charm holder it may be secured at that location by the adjustable sliding loop provided with cinching coil, cylinder, or bead. The eyeglass hanging charm holder may have either a releasable clasp or a fixed O ring of attachment method for fixing the decorative charms, ornaments, strands, or jewelry articles. It is important to note that the eyeglass hanging charm holder provides a single point of hanging for jewelry in which the terminal end for the length of the jewelry is no longer then 6.5 inches.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM

Not Applicable

### LISTING COMPACT DISC APPENDIX

Not applicable

### BACKGROUND OF INVENTION

### Field of the Invention

The present invention relates to an article of jewelry specifically adapted for use with an eyeglass frame.

Eyeglasses typically are produced in the style, type, and classification of the manufacturers production limiting an individuals ability to implement a personal style or artistic expression. There is an eyeglass holder which is decorative and does give an individual the ability to attach a decorative strand or ornament to a pair of eyeglasses, however having a necklace type of attachment to either side or a single side of a pair of eyeglasses can be cumbersome; further for those who wish to simply add a decorative effect to a pair of eyeglasses and do not wish to have the added function of holding the eyeglasses or have a strand attached in two locations, the need for a eyeglass hanging charm holder exists.

### BRIEF SUMMARY OF THE INVENTION

The purpose of the invention is to provide a method of attaching a single strand adornment of decorative nature. The method of attachment is to provide the user with a slid-able loop that is adjustable to fit onto the majority of eyeglass frame temple arms with the primary function of holding any number of decorative charms, ornaments, strands, or jewelry articles to the eyeglass frame from a single point of attachment; thus serving the purpose of providing a single point of hanging in which the terminal end for the length of the jewelry is no longer then 6.5 inches.

Attachment to the eyeglass frame temple arms may be along any length of the arm and any number of eyeglass hanging charm holders may be applied, however each will have a single point of attachment with a terminal end that hangs freely and purely to provide an aesthetic appeal.

Additionally, the object of the design is to provide the user with an ability to interchange either the decorative charm, ornament, strand, jewelry article attached by the use of the eyeglass hanging charm holder or to interchange the entire eyeglass hanging charm holder for another.

### DESCRIPTION OF THE DRAWINGS

FIGS. 1 and 2 show two aspects of the method of hanging a charm on the temple arm of an eyeglass frame.

FIG. 3 represents the eyeglass frame itself.

FIG. 4 shows the actual temple arms that compromise a eyeglass frame.

FIG. 5 shows the eyeglass hanging charm holder in it's entirety.

FIG. 5A shows the single loop or gripping member

FIG. 5B to 5D show the various types of objects that can be used to cinch down on the single loop or gripping member; either coil, cylinder, or bead.

FIG. 6 shows an example of an actual pendant or charm that may be used.

FIG. 7 shows an O ring that provides a method for hanging the pendant or charm.

FIG. 8 shows a releasable clasp that provides a method for hanging the pendant or charm.

### DETAILED DESCRIPTION OF THE INVENTION-PREFERRED EMBODIMENT

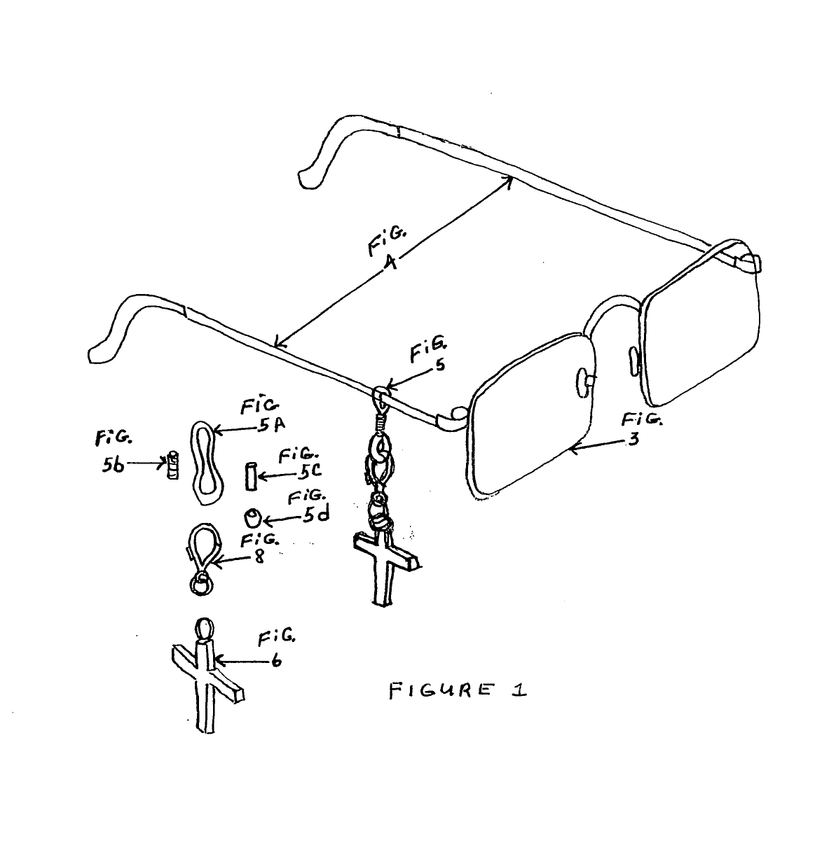

In FIGS. 1 and 2, the eyeglass hanging charm holder according to the present invention is adapted for use with an eyeglass frame 3. The purpose of which is to permit the user to adorn the eyeglass frame in such a manner that is purely esthetic in nature. Eyeglass jewelry usually serves the purpose of holding the eyeglass frame to the person in one fashion or another, however the eyeglass hanging charm holder simply serves the purpose of hanging jewelry to the eyeglass and therefore does not have a required length at the terminal end of the piece as it is not required to extend from temple arm to temple arm or from gripping member to gripping member as may be found with eyeglass ornamental jewelry.

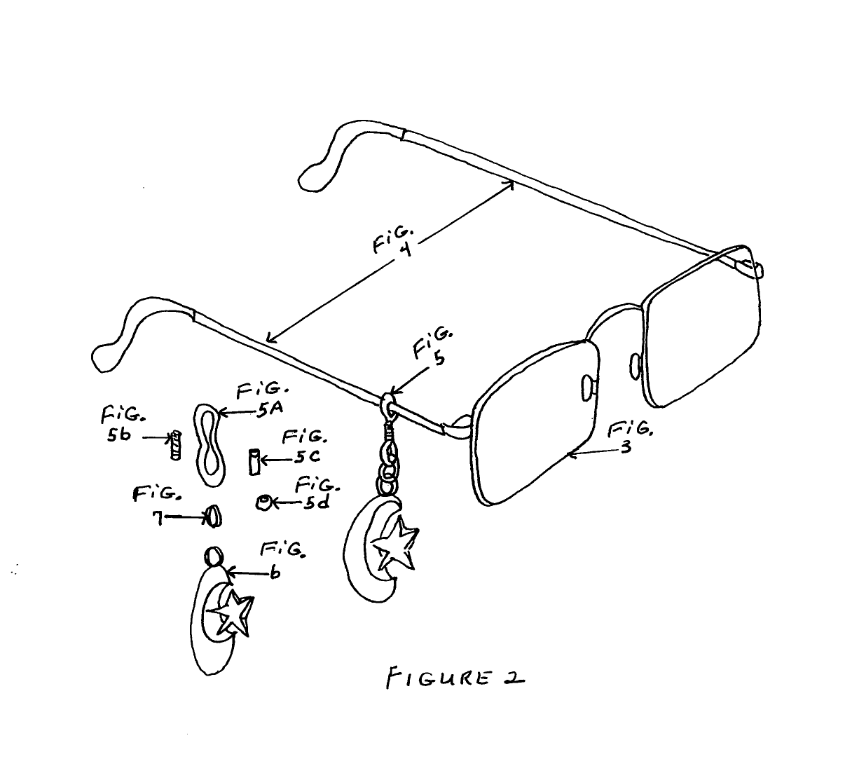

Referring to FIGS. 1 and 2, the eyeglass frame 3 includes temple arms 4 extending from the front of the frame to the users ears. The eyeglass hanging charm holder includes a gripping member FIG. 5 which is adjustable as it is capable of sliding over the either temple arm 4 and then can be positioned on the temple arm any where the user selects and further secured in place by adjustment of the coil 5b, cylinder 5c, or bead 5d.

One to many eyeglass hanging charm holders can be used on either a single temple arm or both sides of 4. The wearer is free to express either a symmetrical or asymmetrical appearance by altering the number and order of eyeglass hanging charm holders on temple arms 4.

Again referring to FIGS. 1 and 2, the gripping member 5 includes a band 5a which hangs on the temple arm and is secured in position with either a coil 5b, cylinder 5c, or bead 5d to hold the charm in position. One of two methods of attaching the charm 6 can be used; the first method is shown in FIG. 1 as the charm is attached to the gripping member 5 with a small O ring 7; the second is shown in FIG. 2 as the charm is attached to the gripping member 5 with a releasable clasp 8.

The materials compromising 5 are all readily available at many jewelry supply stores, however the item in it's entirety is not. The material used for the single loop 5a may be that of rubber, leather, or any number of attractive materials that lend themselves to adorning the object as a whole.

I claim:

1. Eyeglass hanging charm holder, comprising:
an eyeglass frame having a pair of temple arms;
a single gripping member, receivable on a single temple arm of the eyeglass frame;
a single decorative strand connected to one gripping member, respectively;
a decorative strand connected to an attachment anchor thus serving the purpose of holding an ornamental decorative strand or jewelry accessory to the single temple arm of an eyeglass frame.

2. Eyeglass hanging charm holder as recited in claim 1, in which the ornamental decorative strand or jewelry accessory comprises a releasable clasp making it readily releasable from the attachment anchor on either single temple arm, such that plural jewelry accessories may be added, removed, and interchanged.

3. The eyeglass hanging charm holder as recited in claim 1, in which the ornamental decorative strand or jewelry accessory is fixedly attached onto the attachment anchor to be worn on either single temple arm.

4. The eyeglass hanging charm holder as recited in claim 1, in which the ornamental decorative strand or jewelry accessory is either fixedly attached or readily releasable from an attachment anchor that is comprised of a single loop or gripping member with an adjustable sliding bead, cylinder, or coil comprised of metal, plastic, or glass.
